(19) United States
(12) Patent Application Publication
(10) Pub. No.: US 2003/0116640 A1
(43) Pub. Date: Jun. 26, 2003

(54) Reduced-leakage pressure supply for fuel injectors

(75) Inventor: Patrick Mattes, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(73) Assignee: Robert Bosch GmbH

(21) Appl. No.: 10/300,619

(22) Filed: Nov. 21, 2002

(30) Foreign Application Priority Data
Nov. 23, 2001 (DE) 1 01 57 419.3

(51) Int. Cl. F02M 47/02

(52) U.S. Cl. 239/88; 239/96; 239/533.3; 239/533.4

(57) ABSTRACT

The invention relates to a fuel injector which includes a hydraulic booster which can be made to communicate on the high-pressure side with an inlet from a high-pressure source. Between a high-pressure side and a system pressure side, there is a throttle restriction. A throttle element that can be acted upon by pressure from the high-pressure side and that is associated with an outflow opening is received movably in a hollow chamber of the injector body and closes a sealing gap that lengthens a sealing length.

### BACKGROUND OF THE INVENTION

1. Field of the Invention

For actuating fuel injectors, as a rule electromagnets or piezoelectric actuators are used, with which the pressure relief of a control chamber inside the injector body can be brought about. When piezoelectric actuators are used for pressure relief of the control chamber, it is advantageous to boost the stroke of the piezoelectric actuator hydraulically, in order to lengthen the useful stroke and to compensate for temperature effects that arise. To assure the reliable function of a hydraulic booster, the certain refilling of the hydraulic work chamber after a work cycle must be assured.

2. Description of the Prior Art

It is known to use hydraulic boosters to lengthen the stroke travel of piezoelectric actuators and to compensate for thermal effects. After a work cycle, that is, after current has been supplied to the piezoelectric actuator, the refilling of the hydraulic pressure chamber must be assured, so that an adequate volume in the hydraulic pressure chamber of the hydraulic booster is assured before the next work cycle of the piezoelectric actuator occurs. Until now, to maintain the system pressure in the hydraulic chamber of a hydraulic booster, a throttle and a pressure holding valve have been used. While in view of the leakage losses that occur the pressure holding valve is not particularly critical, the losses in efficiency that occur are determined essentially by the design of the throttle restriction. An excessive leak fuel volume flowing out via the throttle restriction has an extremely adverse effect on the efficiency of a hydraulic booster and thus of the fuel injector.

If a filling pin, for instance, is used as the throttle element, then the outflowing volumetric flow Q behaves in accordance with the equation

$${\dot{Q}}_{I} ∼ \frac{{s}^{3} \cdot d}{l} \cdot Δ p$$

in which

s is the height of the sealing gap,

l is the length of the sealing gap, and

d is the diameter of the pin.

Conversely, if the throttle restriction is embodied as a throttle bore, then the outflowing Q behaves in accordance with the following equation

\dot{Q}_{II}˜d²·\sqrt{Δ}p

in which d is the bore diameter.

The courses of the volumetric flows \dot{Q}_{I}, \dot{Q}_{II}, which are dependent on Delta (Δ), can be found from the respective curve courses I and II in the graph in FIG. 2.

To increase the efficiency of the hydraulic booster, a reduction in the volumetric flow Q flowing out via the throttle restriction is necessary.

### OBJECT AND SUMMARY OF THE INVENTION

The embodiment according to the invention has the advantage over the versions known thus far from the prior art that it reduces the volumetric flow flowing out via an annular throttle gap, which flow is the cause of most of the outflowing leak fuel volumetric flow Q. Depending on the high pressure applied, whether it originates in a high-pressure collection chamber (common rail) or a high-pressure pump, it is possible with the provisions of the invention to establish a pressure threshold, and after this pressure threshold is exceeded, the outflowing volumetric flows Q can be minimized.

In a variant embodiment, the throttle restriction is formed by a sleeve with a thin, deformable wall, in the bottom of which sleeve there is a throttle bore. The sleeve is let into the injector body with a tiny gap size. Beyond a specified high-pressure level, the thin-walled sleeve deforms in such a way that its outer wall rests against the surrounding bore wall in the injector body. The remaining outflowing volumetric flow now flows solely through the throttle bore in the sleeve; the annular gap is closed by the deformed wall of the sleeve.

In a further advantageous variant embodiment according to the invention, the throttle restriction can be embodied as a piston/spring assembly. The piston of the piston/spring assembly is penetrated by a central throttle bore and is acted upon by the spring. If the pressure force from the high-pressure source or from the common rail exerted on the end face of the piston exceeds the spring force, then the piston moves against a stop inside the injector body, and the remaining volumetric flow flows out via the central throttle bore in the piston.

It is also possible to embody the throttle restriction by means of a piston guided in a narrow gap, this piston being likewise acted upon by a spring element. If the pressure level from the high-pressure source or from the common rail rises, the piston moves into this bore that surrounds it, so that the sealing length between the piston jacket and the bore is increased, and the outflowing volumetric flow decreases.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a system pressure supply, known from the prior art, for a hydraulic booster and having a pressure holding valve and a throttle;

FIG. 2 shows a comparison of volumetric flows \dot{Q}_{I}, \dot{Q}_{II}, that occur in the prior art embodiments with the reduced volumetric flow \dot{Q}ₙ.

FIG. 3 shows a first variant embodiment of the invention, with a deformable sleeve with a throttle bore in the bottom;

FIG. 4 shows a second variant embodiment of the invention, with a piston/spring assembly and a central throttle bore; and

FIG. 5 shows a third variant embodiment of a throttle restriction, proposed according to the invention, with a sealing length that is established as a function of the pressure level.

### DESCRIPTION OF THE PREFERRED EMBODIMENTS

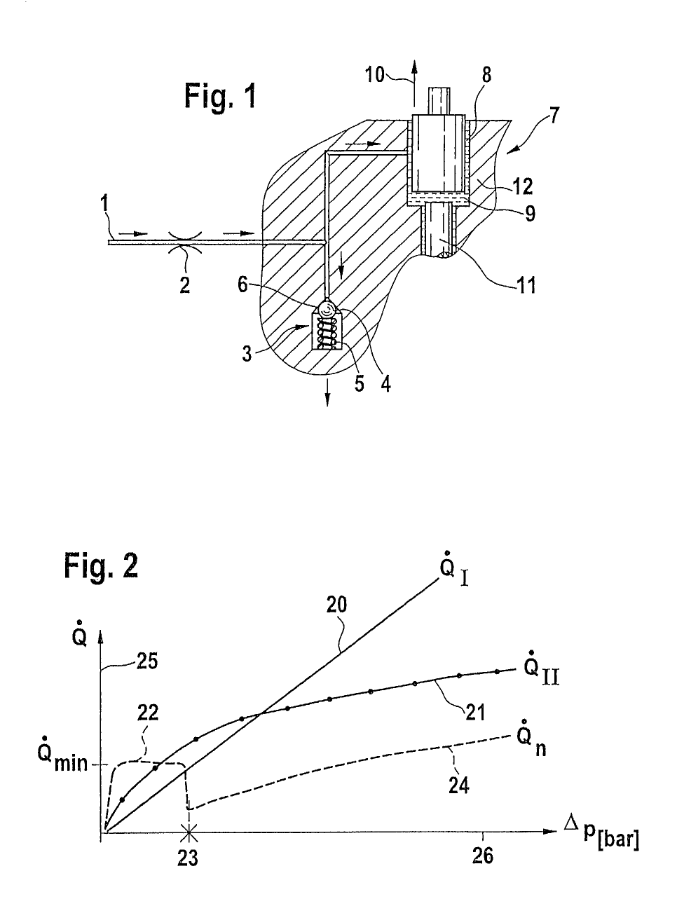

FIG. 1 shows a system pressure supply known from the prior art for a hydraulic booster, with a throttle and a pressure holding valve.

Via an inlet 1 and a high-pressure source, not shown here, which may be a high-pressure collection chamber (common rail) or a high-pressure injection pump, fuel that is at high pressure flows into a line system via a throttle 2. A system pressure valve 3 is received in the line system and includes a ball-shaped closing body 4, which is positioned by means of a spring element 5 in a sealing face 6 and prevents the fuel, shooting in at high pressure, from flowing out again. The volumetric fuel flow at high pressure that passes through the throttle 2 enters the injector body 12 in the region of an annular gap 8 therein and fills up a pressure chamber 9 of a hydraulic booster 7. The pressure chamber 9 is defined on one side by a first piston, shown here only schematically, that has a large hydraulic surface area and by a pinlike piston 11, which is received opposite the first piston and in comparison to it has a smaller effective hydraulic surface area. Reference numeral 10 indicates the volumetric flow of leak fuel that occurs, in this embodiment, between the larger piston and the wall of the injector body 12.

While in terms of the leakages losses that occur at the system pressure valve 3 is not very critical, the volumetric flow 10 of leak fuel flowing out via the annular gap 8 of the hydraulic booster 7 is a disadvantage, because this volumetric flow 10 of leak fuel adversely affects the efficiency of the hydraulic booster 7.

FIG. 2 shows a comparison between the volumetric flows \dot{Q}_{I}, \dot{Q}_{II} that are established in the prior-art embodiment and a reduced volumetric flow \dot{Q}ₙ.

In the graph of FIG. 2, the resultant leak fuel flows 25 are plotted over the pressure difference 26. The straight lines 20 indicate the leak fuel flow \dot{Q}_{I} in a first variant embodiment of the throttle configuration of FIG. 1. If the throttle is embodied as in the prior art shown in FIG. 1, for instance in the form of a pin 11, then a linear leak fuel flow \dot{Q}_{I} is established, which increases with the pressure difference. The outflowing volumetric flow \dot{Q}_{I} can be expressed by the equation

$${\dot{Q}}_{I} ∼ \frac{{s}^{3} \cdot d}{l} \cdot Δ p$$

in which

s is the height of the sealing gap;

l is the length of the sealing gap; and

d is the pin diameter.

The leak fuel volumetric flow \dot{Q}_{I} of the graph in FIG. 2 increases linearly with increasing pressure, which at elevated pressure, of the kind that occur in fuel injectors inevitably causes a great loss of efficiency.

In the graph in FIG. 2, reference numeral 21 designates a leak fuel flow course \dot{Q}ₙ that extends parabolically. If the throttle restriction in FIG. 1, instead of being a pinlike element 11, is in the form of a throttle bore, then the volumetric flow \dot{Q}ₙ of the leak fuel established via this bore behaves in accordance with the following equation:

\dot{Q}_{II}˜d²·\sqrt{Δ}p

in which d is the bore diameter.

In comparison to the volumetric flow \dot{Q}_{II} of the first variant embodiment mentioned, the leak fuel volumetric flow that is established in this embodiment is more favorable; but in terms of its total level, it is still just high enough that the efficiency of a hydraulic booster is adversely affected by the outflowing volumetric flow quantity.

Moreover, the graph in FIG. 2, in dashed lines, shows a reduced leak fuel volumetric flow \dot{Q}ₙ, which characterizes the reduced leak fuel volumetric flow, attainable with the variant embodiments proposed by the invention, via a throttle restriction at the hydraulic booster 7.

Beyond a pressure threshold 23, the leak fuel volumetric flow that comes to be established decreases as indicated by the course 24, that is, \dot{Q}ₙ, and then rises linearly as the pressure difference 26 increases, but without reaching the maximum represented by the curves 20 and 21, which represent the leak fuel volumetric flows \dot{Q}_{I} and \dot{Q}_{II}, respectively. Reference numeral 23 indicates the pressure threshold beyond which, with the embodiment proposed according to the invention, the throttle gap losses drop essentially to zero, and a leak fuel volumetric flow that occurs at elevated pressures is established solely via a throttle bore, or via a sealing gap.

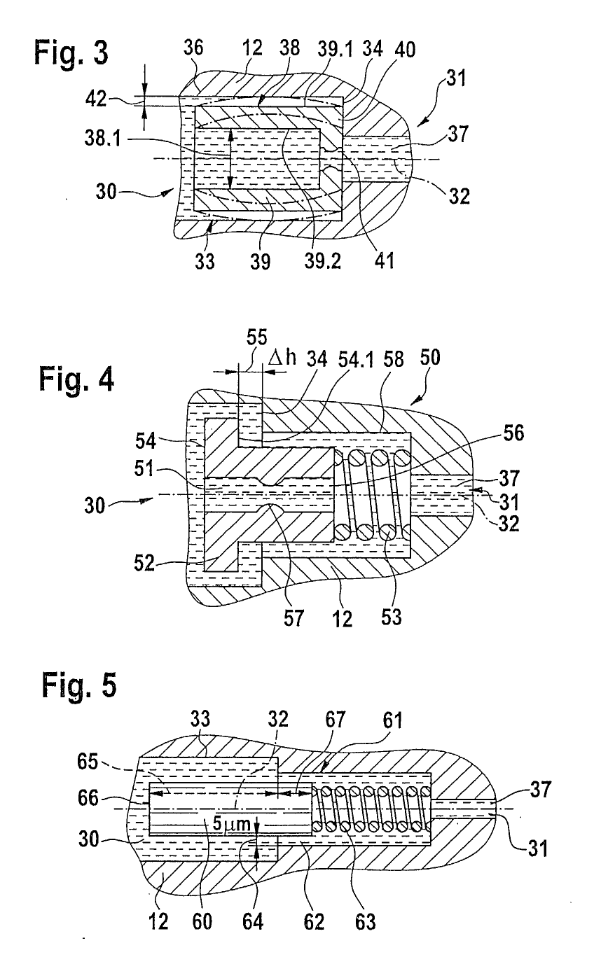

In FIG. 3, a first variant embodiment proposed by the invention can be seen, with a deformable, pistonlike sleeve element with a throttle bore in a bottom region.

As shown in FIG. 3, a hollow chamber 33 is embodied in the injector body 12. The hollow chamber 33 may be configured as a bore, for example, which ends in a stop face 34 in the injector body 12. The stop face 34 can be configured as an annular face, which surrounds an outflow opening 37 on the system pressure side that communicates with the pressure chamber 9 of the hydraulic booster 7. on the side marked 30 of the deformable piston, shown in FIG. 3, as a throttle element, the high pressure from the common rail or other high-pressure source, such as a high-pressure injection pump, prevails, while system pressure prevails on the side of the throttle element 38 marked 31.

In the first variant embodiment shown in FIG. 3, the throttle element 38 movable in the hollow chamber 33 is embodied as a deformable, pistonlike throttle element. On its side toward the high-pressure side 30, the pistonlike throttle element 38 adjoins an interior 38.1, which is defined by a thin wall 39 and by a bottom region 40. The inside surface of the wall 39 of the throttle element 38 is marked 39.2, while the outside of the wall 39 is marked 39.1. In the undeformed state, a gap size 42 prevails between the outside 39.1 of the piston wall 39 and the wall 36 of the hollow chamber 33. The annular gap defined by the gap size 42 surrounds the pistonlike throttle element 38 in such a way that an annular gap is established over the axial length of the throttle element, since the outside 39.1 of the wall 39 of the throttle element 38 and the wall 36 of the hollow chamber 33 configured as a bore are just barely not touching. The gap size 42 between the outside 39.1 of the throttle element 38 and the wall 36 of the hollow chamber 33 is on the order of magnitude of a few micrometers (μm), for instance about 5 μm.

A throttle bore 41 acting as a throttle restriction is let into the bottom 40 of the throttle element 38 and is located symmetrically to both the throttle element 38 and the outflow opening 37, or in other words is located on the axis of symmetry 32 of the arrangement shown in FIG. 3. The bore diameter of the throttle bore 41 and annular gap defined by the gap size 42 between the throttle element 38 and the hollow chamber 33 are designed such that the total of the volumetric flows via the throttle element 38 and the bore 41 meet the requirements of the injector. When the fuel pressure applied to the high-pressure side 30 is high, the pressure buildup via the annular gap 42 between the outside 39.1 of the throttle element 38 and the wall 36 of the hollow chamber 33 causes a deformation of the wall 39 of the throttle element 38, so that the remaining volumetric flow flowing out via the outflow opening 37 is now capable of flowing out only via the pressure valve 41. As indicated by the wall 39, shown in dashed lines, of the throttle element 38 in FIG. 3, the annular gap 42 is closed, so that the volumetric flow 10 flowing out via the annular gap in the view shown in FIG. 1 becomes zero. The maximum volumetric flow that is capable of flowing out via the outflow opening 37 on the system pressure side 31 via the throttle element 38 is thus drastically limited.

FIG. 4 shows a second variant embodiment with a piston/spring assembly, in which the piston includes a central throttle bore.

It can be seen from FIG. 4 that a piston 52 is let into the hollow chamber 33 in the injector body 12, and this piston is braced on one of its face ends 56 by a spring element 53. The spring element 53 is moreover braced on an annular face of the injector body 12 that surrounds the outflow opening 37.

The piston 52 includes one face end 54, oriented toward the pressure side 30, while the aforementioned face end 56 points toward the system pressure side 31, or in other words toward the outflow opening 37 of the hydraulic booster 7. The back side of the face end 54 is marked 54.1 and is located facing a stop face 34 in the injector body 12. The stop face 34 extends annularly around a bore 58 in the injector body 12. Between the back side 54.1 of the face end 54 of the piston 52 and the stop face 34, a spacing 55 (Δh) is formed, which is determined essentially by the relaxed state of the spring element 53. If the spring element 53 is relaxed, then an open gap Δ exists between the back side 54.1 of the face end 54 of the piston 52 and the stop face 34 in the injector body 12.

If the pressure on the pressure side 30 of the injector body 12 rises, it acts on the end face 54 of the piston 52. The piston 52 is pressed in the direction of the stop face 34, counter to the spring force generated by the spring element 53, and rests on this stop face, if the pressure on the high-pressure side 30 is high enough, so that the gap 55 marked in FIG. 4 by the spacing (Δh) becomes zero. Advantageously, the block length of the spring element 53 is designed such that this spring element does not hinder the inward motion of the back side 54.1 of the end face 43 against the annularly configured annular face 34 in the injector body 12.

If the back side 54.1 of the end face 54 is resting on the annularly configured stop face 34 of the injector body 12, then the volumetric flow flowing out via the outflow opening 37 of the hydraulic booster 7 is capable of flowing through only the conduit 51, centrally penetrating the piston 52, and in which a throttle restriction 57 is embodied. The development of an additional leak fuel volumetric flow via a gap is effectively prevented by the contact of the back side 54.1 of the piston 52 with the annular stop face 34 in the injector body 12. Below a pressure level on the high-pressure side 30, which level is determined by means of the spring constant of the spring element 53, the pistonlike throttle element 52 remains open, so that the volumetric flow is formed from the total of the valve flow and the throttle flow. As soon as the pressure, established by the spring element 53, on the high-pressure side 30 is exceeded, the pistonlike throttle element 52 closes; that is, it rests with the back side 54.1 of its end face 54 on the annular face 34 in the injector body, so that the remaining volumetric flow is then determined only by the throttle restriction 57 in the through conduit 51.

In FIG. 5, a third variant embodiment of the version proposed by the invention can be seen, with a sealing length that is established as a function of the pressure level.

In the variant embodiment of FIG. 5, a pinlike piston 60 is received movably in a piston guide in the injector body 12. The pinlike piston 60 is symmetrical to the line of symmetry 32, which as shown in FIG. 5 coincides with the axis of symmetry of the outflow opening 37 of the hydraulic booster 7. Reference numeral 30 designates the high-pressure side in the injector body 12, while reference numeral 31 designates the system pressure side.

The pinlike piston 60 includes a first face end 66 and a second face end 67. A spring element 63 rests on its second face end 67 and is braced, on the side opposite the second face end 67, on an annular face surrounding the outflow opening 37.

In the position shown in FIG. 5 of the pinlike throttle element 60, a gap size 64 is established between the jacket face of the pinlike piston 60 and the wall of the piston guide 61; the length of the gap established is identified by reference numeral 67. In this position shown in FIG. 5 of the pinlike piston 60 in the injector body 12, the minimum sealing length of the sealing gap is shown. The minimum sealing length 67 is determined by the untensed spring 63. In the position shown in FIG. 5 of the pinlike throttle element 60 inside the hollow chamber 33 of the injector body 12, the volume flowing out of the hydraulic booster via the outflow opening 37 flows out via the sealing gap 64, which in the position shown in FIG. 5 has only a slight sealing length 67. If conversely the pressure on the pressure side 30 in the injector body 12 rises, then the first face end 66 of the pinlike piston 60 is subjected to high pressure, and the pinlike, pistonlike throttle element 60 moves into the piston guide 61, thereby increasing the overlap between the wall of the piston guide 61 and the jacket face of the piston of the pinlike throttle element 60 in the axial direction thereof. The maximum inward motion of the pinlike throttle element 60 into the piston guide 61 is limited by the block length of the compression spring 63 that acts on the second face end 67 of the pinlike throttle element 60. In the state in which the pinlike throttle element 60 has moved all the way into the piston guide 61, an axially extending maximum sealing length 65 ensues. Depending on the length of the sealing gap 65 in the axial direction, the leakage losses in the hollow chamber 33 decrease; accordingly, the leakage losses are limited by the length of the sealing gap 65 between the piston guide 61 and the pinlike throttle element 60. The sealing length increases when the pinlike throttle element 60 has moved into the piston guide 61, so that the fuel quantity flowing out via the annular gap 65 decreases. In the terminal position of the pinlike piston element 60, which is defined by the block length of the spring element 63, the volumetric flow flowing out via the outflow opening 37 is limited to its minimum value.

The foregoing relates to preferred exemplary embodiments of the invention, it being understood that other variants and embodiments thereof are possible within the spirit and scope of the invention, the latter being defined by the appended claims.

I claim:

1. A fuel injector having an injector body (12) which includes a hydraulic booster (7) whose pressure chamber (9) is filled from a system pressure region, the injection comprising
a throttle (2) that can be made to communicate with the high-pressure region,
a system pressure valve (3) for maintaining the pressure in the system pressure region,
a throttle element (38, 52, 60) associated with an outflow opening (37) and that can be acted upon by pressure from the high-pressure side (30),
a spring element (63) acting on the throttle element (38, 52, 60), the throttle element being pistonlike and being guided movably in a longitudinal guide (61),
an annular gap (64) formed between the longitudinal guide (51) and the pistonlike throttle element, the sealing length (65, 67) of the gap (64) between the longitudinal guide (61) and the pistonlike throttle element (60) being variable.

2. The fuel injector according to claim 1, wherein the throttle element (38, 52, 60) in the injector body (12) points with one face end (35, 56, 67) toward the outflow opening (37).

3. The fuel injector according to claim 1, wherein the throttle element (38) is embodied as a deformable piston whose wall (39) together with the wall (36) of the hollow chamber (33) forms an annular gap (42).

4. The fuel injector according to claim 3, wherein the throttle element (38) includes a hollow chamber (38.1), which is open toward the high-pressure side (30) and whose boundary face (40) pointing toward the system pressure side (31) includes a throttle bore (41).

5. The fuel injector according to claim 3, wherein the throttle element (38) cooperates with a face-end stop face (35) on an annular face (34) in the injector body (12), which annular face defines the outflow opening (37).

6. The fuel injector according to claim 4, wherein, when pressure is exerted on the throttle element (38) from the high-pressure side (30), its wall (39) is deformed such that the outside (35) of the wall (39) rests on the wall (36) of the hollow chamber (33) and closes the annular gap (42).

7. The fuel injector according to claim 1, wherein the pistonlike throttle element (52, 60) is braced by a spring element (53, 63), the spring element having one end braced on one face end (56, 67) of the throttle element (52, 60) and its other end resting on the injector body (12).

8. The fuel injector according to claim 7, wherein that the pistonlike throttle element (52) includes a through conduit (51), which has a throttle restriction (57).

9. The fuel injector according to claim 7, wherein the pistonlike throttle element (52) has a face end (54), pointing toward the high-pressure side (30), and a back side (54.1) cooperating with a stop face (34) of the injector body (12).

10. The fuel injector according to claim 7, wherein the pistonlike throttle element (52) is kept by the spring element (53) at a spacing (55) Δ from the stop face (34) of the injector body (12) and upon a pressure increase on the high-pressure side (30) is pressed sealingly against the stop face (34) of the injector body (12).

11. The fuel injector according to claim 7, wherein the pistonlike throttle element (60) is guided movably in the injector body (12) in a longitudinal guide (61) and with it forms an annular gap (64).

12. The fuel injector according to claim 11, wherein the pistonlike throttle element (60) together with the piston guide (61) defines a sealing gap of variable length (64, 67).

13. The fuel injector according to claim 12, wherein the minimum length (67) of the sealing gap is defined by the relaxed length of the spring element (63).

14. The fuel injector according to claim 12, wherein the maximum length (65) of the sealing gap is determined by the block length of the spring element (63).

15. The fuel injector according to claim 13, wherein the maximum length (65) of the sealing gap is determined by the block length of the spring element (63).
